(19) United States
(12) Patent Application Publication
(10) Pub. No.: US 2009/0129847 A1
(43) Pub. Date: May 21, 2009

(54) MAGNETIC ATTACHMENT OF PRINTER CUTTER BLADE

(75) Inventors: Stacy L. Arrington, Raleigh, NC (US); Richard H. Harris, Raleigh, NC (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/941,167

(22) Filed: Nov. 16, 2007

(51) Int. Cl. B41J 11/00

(52) U.S. Cl. 400/621

(57) ABSTRACT

Disclosed is a thermal receipt printer including a printer frame having a base and two blade flanges extending from the base. The thermal receipt printer further includes a stationary blade located at the two blade flanges and at least one magnet located in at least one magnet hole in each blade flange of the two blade flanges, a magnetic field of the at least one magnet retaining the stationary blade to the two blade flanges.

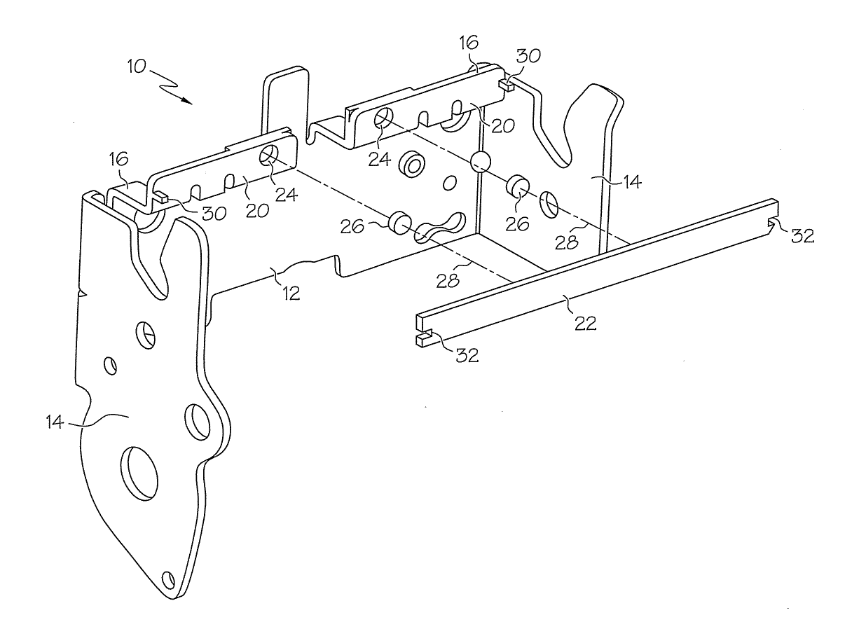

### BACKGROUND OF THE INVENTION

1. Field of the Invention

This invention generally relates to thermal receipt printers and more particularly to attachment of blades in thermal receipt printers.

2. Description of Background

Devices such as thermal receipt printers, which print information on paper fed through the receipt printer, generally include a mechanism which cuts the paper when the printing operation is completed. The cutting mechanism is often scissor-like, with one blade fixed in position in the receipt printer and a second blade that moves to perform a cutting action on the paper which is disposed between the first blade and the second blade. The blades often wear and must be replaced for the receipt printer to reach its full useful life. The fixed blade, however, is typically welded into place in the receipt printer, thus making replacement of the fixed blade difficult and time consuming.

Further, the welding process to install the blade, either initially or at replacement, applies high temperatures to the blade, which may effect the hardness of the blade and/or distort the shape of the blade and the structure to which the blade is welded. These conditions may lead to premature failure of the receipt printer, and increased product cost due to secondary operations necessary to straighten the structure after welding.

### SUMMARY OF THE INVENTION

The shortcomings of the prior art are overcome and additional advantages are provided through the provision of a thermal receipt printer wherein a stationary blade is retained by a magnetic field. The thermal receipt printer includes a printer frame having a base and two blade flanges extending from the base. The thermal receipt printer further includes a stationary blade located at the two blade flanges and at least one magnet located in at least one magnet hole in each blade flange of the two blade flanges, a magnetic field of the at least one magnet retaining the stationary blade to the two blade flanges.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which effectively retains a stationary blade in a thermal receipt printer and also allows the stationary blade to be removed and replaced toollessly, if necessary.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

The FIGURE is an exploded view of a blade attachment scheme utilizing magnets.

The detailed description explains the preferred embodiments of the invention, together with advantages and features, by way of example with reference to the drawings.

### DETAILED DESCRIPTION OF THE INVENTION

Shown in the FIGURE is an exploded view of the pertinent parts of a thermal receipt printer. The basic structure of the thermal receipt printer is provided by the printer frame 10. The printer frame 10 of the FIGURE is formed to include a base 12 and one or more sidewalls 14 extending from the base 12. The frame 12 includes at least one blade flange 16. The embodiment shown in the FIGURE includes two blade flanges 16 which extend from the base 12 substantially perpendicular to the base 12, each blade flange 16 having a locating face 20 where at least a portion of a stationary blade 22 is to be disposed and affixed. The two located faces 20 shown in the FIGURE are substantially parallel to the base 12, but other quantities, orientations and configurations of locating faces 20 may be utilized depending on the desired orientation of the stationary blade 22. For example, one locating face 20 may be utilized, and/or locating faces 20 may be formed to be at an alternative angle relative to the base 12.

The locating faces 20 include one or more magnet holes 24. The magnet holes 24 are not necessarily through-holes, and are sized in depth and opening size to be receivable of at least one magnet 26. The magnets 26 shown have substantially circular cross-sections, but magnets 26 of other cross-sectional shapes, including rectangular or polygonal, may be utilized along with correspondingly-configured magnet holes 24. Each magnet 26 is polarized along a magnet axis 28. The magnets 26 are disposed in the magnet holes 24. The stationary blade 22 is then placed on the locating faces 20 over at least one magnet 26. Magnet 26 holds the stationary blade 22 in place on the locating face 20.

In some embodiments, the printer frame 10 may include on or more locating features to properly orient the stationary blade 22. For example, as shown in the FIGURE, a locating tab 30 is disposed at each blade flange 16. Each locating tab 30 extends from the blade flange 16 in a direction substantially perpendicular to the locating face 20. Each locating tab 30 is configured to be engagable in a locating slot 32 in the stationary blade 22. The embodiment illustrated in the FIGURE includes two locating tabs 30 which fit into two locating slots 32, but other quantities of locating tabs 30 and locating slots 32 are contemplated within the scope of the current invention. Further, other locating schemes are contemplated, including, for example, locating slots 32 disposed in the printer frame 10 which receive locating tabs 30 disposed on the stationary blade 22.

Utilizing magnets 26 to secure the stationary blade 22 allows for quick and toolless replacement of the stationary blade 22 in the case of the stationary blade becoming worn or damaged from use.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A thermal receipt printer comprising:
a printer frame including a base and two blade flanges extending from the base;
a stationary blade disposed at the two blade flanges; and
at least one magnet disposed in at least one magnet hole in each blade flange of the two blade flanges, a magnetic field of the at least one magnet retaining the stationary blade to the two blade flanges, the magnetic field and the two blade flanges preventing movement of the stationary blade in the thermal receipt printer.

2. The thermal receipt printer of claim 1 wherein the stationary blade includes at least one locating slot, the at least one locating slot receivable of a locating tab disposed on at least one blade flange of the two blade flanges.

3. The thermal receipt printer of claim two wherein there are two locating slots.

4. The thermal receipt printer of wherein there are two magnets.
